(19) United States
(12) Patent Application Publication
(10) Pub. No.: US 2017/0187767 A1
(43) Pub. Date: Jun. 29, 2017

(54) METHOD FOR DETECTING DATA STREAM SYNCHRONIZATION

(71) Applicant: MStar Semiconductor, Inc., Hsinchu Hsien (TW)

(72) Inventor: Chun-Chieh Wang, Hsinchu Hsien (TW)

(21) Appl. No.: 15/363,091

(22) Filed: Nov. 29, 2016

(30) Foreign Application Priority Data
Dec. 29, 2015 (TW) 104144181

(51) Int. Cl. H04L 29/06; H04L 12/707

(52) U.S. Cl. CPC H04L 65/4076; H04L 45/24

(57) ABSTRACT

A method for detecting data stream synchronization includes receiving a first data stream, verifying a first data sequence corresponding to a first data sequence field, generating a first flag of successful synchronization verification when the first data sequence is successfully verified, verifying a second data sequence corresponding to a second data sequence field, and generating a second flag of successful synchronization verification when the second data sequence is successfully verified.

This application claims the benefit of Taiwan application Serial No. 104144181, filed Dec. 29, 2015, the subject matter of which is incorporated herein by reference.

### BACKGROUND OF THE INVENTION

Field of the Invention

The invention relates in general to a method for detecting data stream synchronization, and more particularly, to a method capable of quickly detecting data stream synchronization for a transmission and multiplexing configuration control (TMCC) data stream at a receiver of an Integrated Services Digital Broadcasting—Terrestrial (ISDB-T) system. Further, the synchronization detection method of the present invention is also applicable as a method capable of quickly detecting data stream synchronization of a transmission parameter signaling (TPS) data stream at a receiver of a Digital Video Broadcasting—Terrestrial (DVB-T).

Description of the Related Art

As communication technologies continue progressing, various kinds of Integrated Services Digital Broadcasting—Terrestrial (ISDB-T) systems are gradually applied in people's daily lives. There are two ways for reception for an ISDB-T system—using a television or a set-top box (STB). Older television may be additionally installed with an STB. In an STB, in addition to basic chipsets, a built-in ISDB-T module needs to be provided.

In an ISDB-T system, orthogonal frequency division multiplexing (OFDM) systems are adopted in a transmitter and a receiver, and there are parameters of numerous data processing mechanisms in an OFDM system, e.g., parameters including indicator of transmission parameter switching, carrier convolutional coding rate and signal interleaving length. When applied to a transmitter, these parameters are transmitted with transmission and multiplexing configuration control (TMCC) signals. For a receiver, before TMCC signals are parsed, the remaining signal processing mechanisms are the receiver cannot be conducted.

To parse TMCC signals, synchronization detection is to be primarily performed on the TMCC signals. When TMCC signals are detected as not yet synchronized with the timing of the receiver, signals cannot be directly captured due to timing offset in the signals. The receiver continues the synchronization detection till the receiver adjusts its timing to be completely synchronized with the TMCC signals. To realize synchronization detection in an ISDB-T system, certain known synchronization bits are placed in each TMCC data frame in the data stream of the TMCC signals. For current synchronization detection mechanisms, the fields of synchronization bits in two TMCC data frames received need to be observed, and corresponding data in these fields of synchronization bits is compared with the known synchronization bits, e.g., by a match filter or a correlator, to determine whether the data in the fields of synchronization bits corresponds to the known synchronization bits, to further determine whether the received TMCC signals are synchronous.

However, in conventional synchronization detection mechanisms, the fields of synchronization bits of two TMCC data frames received need to be observed before determining whether the TMCC signal stream is synchronous and hence adjusting the timing of the receiver. The time needed for the above process inevitably exceeds the time period of one TMCC data frame, and is considered quite time consuming. For example, for an OFDM signal with a guard interval of ⅛, in an optimum situation, the time needed for synchronizing and parsing TMCC data is as high as 250.614 ms.

Therefore, it is necessary to develop a method for quickly detecting synchronization to reduce the synchronization detection time of TMCC data, and to apply the synchronization detection technology of the present invention to a Digital Video Broadcasting—Terrestrial (DVB-T) system to shorten the time needed for channel selection and channel scanning.

### SUMMARY OF THE INVENTION

A method for detecting data stream synchronization is provided according to an embodiment of the present invention. The method includes receiving a data stream by a receiver, verifying a first data sequence in the data stream corresponding to a first data sequence field, generating a first flag of successful synchronization verification when the first data sequence is successfully verified, verifying a second data sequence in the data stream corresponding to a second data sequence field, and generating a second flag of successful synchronization verification when the second data sequence is successfully verified. The first data sequence field is a field of synchronizing signal sequence, the second data sequence field is a data sequence field of data segment type identification and the second data sequence is located subsequent to the first data sequence.

A method for detecting data stream synchronization is further provided according to another embodiment of the present invention. The method includes receiving a data stream by a receiver, verifying a first data sequence in the data stream corresponding to a first data sequence field, generating a first flag of successful synchronization verification when the first data is successfully verified, verifying a second data sequence in the data stream corresponding to a second data sequence field, and generating a second flag of successful synchronization verification when the second data sequence is successfully verified. The first data sequence field is a field of synchronizing signal sequence, the second data sequence field is a field of non-synchronizing signal sequence, and the first data sequence and the second data sequence are located in the same data frame.

A method for detecting data stream synchronization is further provided according to another embodiment of the present invention. The method includes receiving a data stream by a receiver, verifying a first data sequence in the data stream corresponding to a first data sequence field, generating a first flag of successful synchronization verification when the first data is successfully verified, verifying a second data sequence in the data stream corresponding to a second data sequence field, and generating a second flag of successful synchronization verification when the second data sequence is successfully verified. The first data sequence field is a field of synchronizing signal sequence, the second data sequence field is a data sequence field of transmission parameter signaling (TPS) length indicator, and the second data sequence is located subsequent to the first data sequence.

A synchronization detection decoding circuit is further provided according to another embodiment of the present invention. The synchronization detection decoding circuit includes a memory, an address generating circuit and a synchronization decision circuit. The memory buffers a data stream. The address generating circuit, coupled to the memory, outputting a plurality of addresses in the data stream corresponding to a plurality of data sequence fields. The address generating circuit includes a plurality of synchronization matching circuits, and generates data of the plurality of addresses. The synchronization decision circuit, coupled to the memory and the address generating circuit, determines whether the data stream is synchronous according to the plurality of addresses corresponding to the plurality of data sequence fields.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a system architecture of a receiver of an Integrated Digital Services Broadcasting—Terrestrial (ISDB-T) system to which a method for detecting data stream synchronization of the present invention is applied;

FIG. 2 is a schematic diagram of a data structure in a transmission and multiplexing configuration control (TMCC) signal;

FIG. 3 is a flowchart of a method for detecting data stream synchronization according to an embodiment of the present invention; and

FIG. 4 is a block diagram of a synchronization detection decoding circuit of a TMCC decoder.

### DETAILED DESCRIPTION OF THE INVENTION

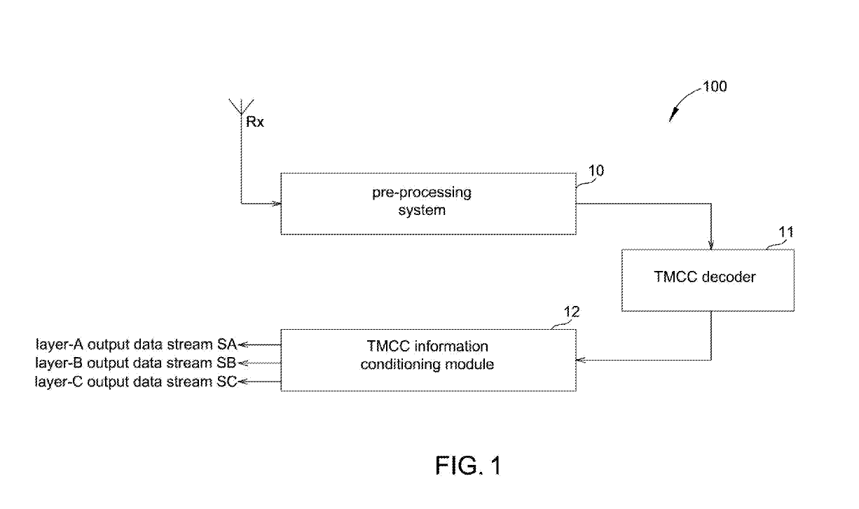

FIG. 1 is a schematic diagram of a system architecture of a receiver of an Integrated Digital Services Broadcasting—Terrestrial (ISDB-T) system to which a method for detecting data stream synchronization of the present invention is applied. For illustration purposes, the present invention considers a data synchronization mechanism at a receiver 100 of an ISDB-T system. In FIG. 1, the receiver 100 includes a pre-processing system 10, a transmission and multiplexing configuration control (TMCC) decoder 11 and a TMCC information conditioning module 12. The TMCC decoder 12 receives an output signal of the pre-processing system 10, and retrieves a parameter needed by the TMCC data conditioning module 12 for the use of the TMCC data conditioning module 12. In the present invention, the TMCC decoder 11 is capable of quickly detecting synchronization according to a received TMCC data stream and retrieving the TMCC data stream within a shortest time period possible, such that all components of the subsequent TMCC data conditioning module 12 become immediately operable. Details of a data structure in the TMCC data stream and the method for detecting synchronization are given below.

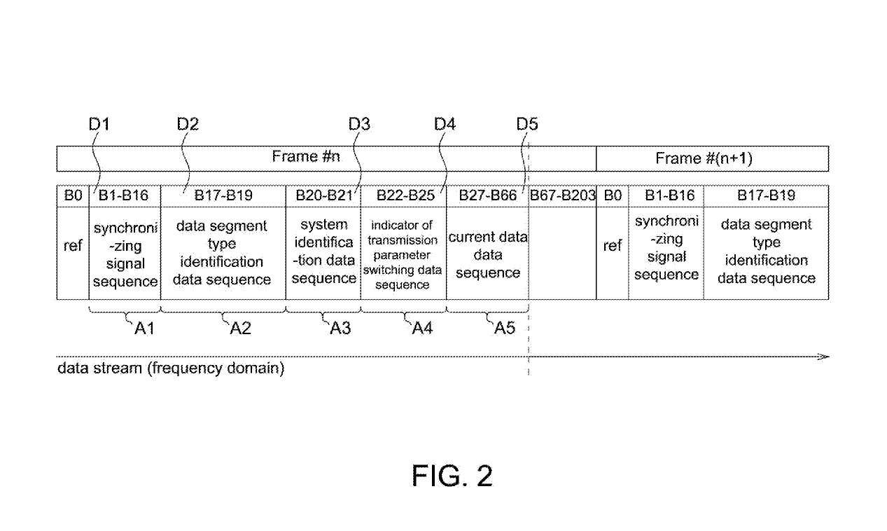

FIG. 2 shows a schematic diagram of a data structure in a TMCC signal. As shown in FIG. 2, the TMCC data stream is divided in form of data frames, e.g., the n^{th} data frame Frame #n and the (n+1)^{th} data frame Frame #(n+1). Each data frame includes a plurality of bits, and is divided into data sequences. For example, the 0^{th} bit of the n^{th} data frame Frame #n is a reference bit. After the 0^{th} bit, bits B1 to B16 are a synchronizing signal sequence D1, bits B17 to B19 are a data segment type identification data sequence D2, bits B20 to B21 are a system identification data sequence D3, bits B22 to B25 are an indicator of transmission parameter switching data sequence D4, bits B27 to B66 are current information data sequence D5, and bits B67 to B203 are future system information. The above data sequences may be regarded as data sequences in the data frame Frame #n. In other words, in the embodiment, in order to have all components in the TMCC data conditioning module 12 immediately operable, it is critical that data corresponding to the bits B1 to B66 in the data frame Frame #n be reliably retrieved. However, when the data frame Frame #n is received at the receiver, the data sequences therein are not always synchronized with the corresponding data fields. For example, when the synchronizing signal sequence D1 in the data frame Frame #n is received by the receiver, it may not exactly fall in the corresponding data field A1. When any of the synchronizing signal sequence D1, the data segment type identification data sequence D2, the system identification data sequence D3, the indicator of transmission parameter switching data sequence D4, and the current information data sequence D5 is asynchronous, the data corresponding to the bits B1 to B66 cannot be directly retrieved. Details of detecting whether the signals of the fields corresponding to the bits B1 to B66 in the data frame Frame #n are synchronous are given below.

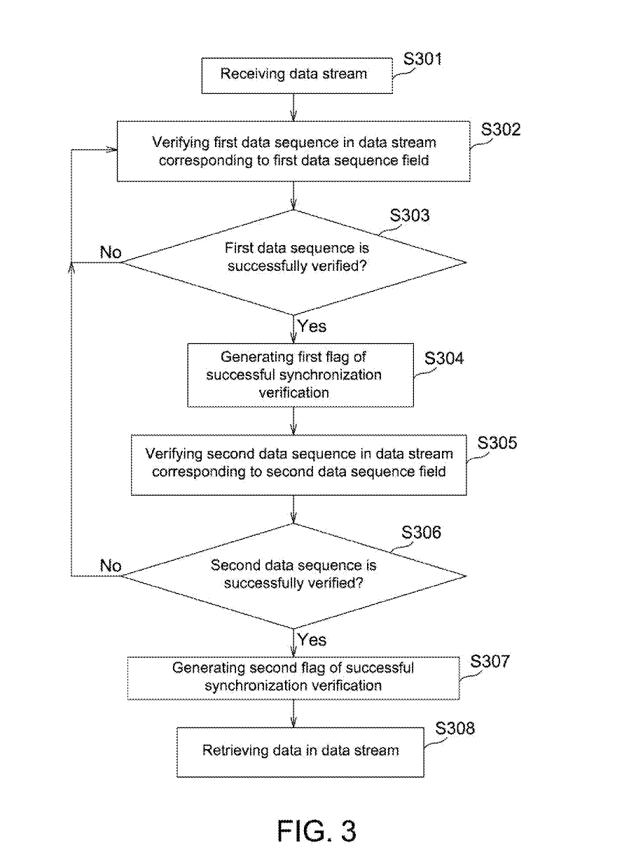

FIG. 3 shows a flowchart of a method for detecting data stream synchronization according to an embodiment of the present invention. The method for detecting data stream synchronization of the present invention is not limited to steps S301 to S308 in FIG. 3. For example, steps S305 and S306 may be omitted, or additional steps may be added between steps S307 and S308. The method is described as below.

In step S301, a data stream is received.

In step S302, in the data stream, a first data sequence corresponding to a first data sequence field is verified.

In step S303, it is determined whether the first data sequence is successfully verified. Step S304 is performed if so, or else step S302 is iterated.

In step S304, a first flag of successful synchronization verification is generated.

In step S305, in the data stream, a second data sequence corresponding to a second data sequence field is verified.

In step S306, it is determined whether the second data sequence is successfully verified. Step S307 is performed if so, or else step S302 is iterated.

In step S307, a second flag of successful synchronization verification is generated.

In step S308, data in the data stream is retrieved.

The above steps are described in detail below. In step S301, the receiver 100 receives a TMCC data stream, which has a configuration as shown in FIG. 2 and may however not be synchronous at the receiver 100. In step S302, the receiver 100 verifies whether a first data sequence, in the data stream, corresponding to a first data sequence field satisfies a condition to determine whether the first data sequence of the first data sequence field is synchronous. The first data sequence field may be a data sequence field of synchronizing signal sequence, and corresponds to the synchronizing signal sequence in the bits B1 to B16. The synchronizing signal sequence is defined in the ISDB-T specification as a table below:

| Index of data frame | Synchronizing signal sequence |
|---|---|
| Frame #1 | 0011010111101110 |
| Frame #2 | 1100101000010001 |
| Frame #3 | 0011010111101110 |
| Frame #4 | 1100101000010001 |

The receiver 100 verifies whether the data sequence in the data stream corresponding to the first data sequence field (bits B1 to B16) is a synchronizing signal sequence. For example, the receiver 100 compares the data sequence in the received data stream corresponding to the first data sequence field with the synchronizing signal sequence “001101011110111” or “1100101000010001” by a correlator. In step S303, it is checked whether the data sequence of the first data sequence field matches the synchronizing signal sequence. If the two match, it means that the synchronization verification is successful, and step S304 is then performed to generate a first flag of successful synchronization verification. If the two do not match, it means that the synchronization verification is not successful, and step S302 is iterated. The verification mechanism of the synchronizing signal sequence may be represented by a program code below:

match_sync_word=(match_sync_word_1∥match_sync_word_2)
match_sync_word_1=(B1-B16==0011010111101110)
match_sync_word_2=(B1-B16==1100101000010001)

In the program code above, match_type_word represents the first flag of successful synchronization verification.

In step S305, the receiver 100 verifies whether a second data sequence in the data stream corresponding to a second data sequence field satisfies a condition to determine whether the second data sequence of the second data sequence field is synchronous. The second data sequence field may be a data sequence field of data segment type identification, which corresponds to the data sequence field of data segment type identification at the bits B17 to B19. The data segment type identification data sequence is defined in the ISDB-T specification as a table below:

| Type of data segment type | |
|---|---|
| identification data sequence | Value |
| Differential | 111 |
| Synchronous | 000 |

The receiver 100 verifies whether the data sequence in the received data stream corresponding to the second data sequence field (the bits B17 to B19) is the segment type identification data sequence. For example, the receiver 100 compares the data sequence in the received data stream corresponding to the second data sequence field with the segment type identification data sequence “111” or “000” by a correlator. In step S306, it is checked whether the data sequence of the second data sequence field matches the segment type identification data sequence. If the two match, it means that the synchronization verification is successful and step S307 is performed to generate the second flag of successful synchronization verification. If the two do not match, it means that the synchronization has failed and step S302 is iterated. The verification mechanism of the segment type identification data sequence may be represented by a program code below:

match_segment_type=(segment_type_dif∥segment_type_coh)
segment_type_dif=(B17-B19==111)
segment_type_coh=(B17-B19==000)

In the above program code, match_segment_type represents the second flag of successful synchronization verification.

When the first flag of successful synchronization verification and the second flag of successful synchronization verification are received, it means that the TMCC data stream is synchronous, and the data in the data stream may be directly retrieved according to step S308.

To further enhance the accuracy of synchronization detection, the synchronization verification method of the present invention may add a step of multiple verification sequences between steps S307 and S308 in the process in FIG. 3, as described below. After step S307 is performed, the receiver 100 verifies whether a third data sequence in the data stream corresponding to a third data sequence field satisfies a condition to determine whether the third data sequence of the third data sequence field is synchronous. The third data sequence field may be a data sequence field of system identification, which corresponds to the system identification data sequence at bits B20 to B21. The system identification data sequence is defined in the ISDB-T specification as a table below:

| Value of system identification | |
|---|---|
| data sequence | Meaning |
| 00 | System based on this specification |
| 01 | System for ISDB-TSB |
| 10, 11 | Reserved |

The receiver 100 verifies whether the data sequence in the received data stream corresponding to the third data sequence field (bits B20 to B21) is the data sequence field of system identification. The verification mechanism of the system identification data sequence may be represented by a program code below:

match_system_id=(B20-B21==00)

In the above program code, match_system_id represents a third flag of successful synchronization verification.

After completing the above verification mechanism of the system identification data sequence, the receiver 100 verifies whether a fourth data sequence in the data stream corresponding to a fourth data sequence field satisfies a condition to determine whether the fourth data sequence of the fourth data sequence field is synchronous. The fourth data sequence field may be a data sequence field of indicator of transmission parameter switching, which corresponds to the indicator of transmission parameter switching data sequence at bits B22 to B25. The indicator of transmission parameter switching data sequence is defined in the ISDB-T specification as a table below:

| Value of indicator of | |
|---|---|
| transmission parameter | |
| switching data sequence | Meaning |
| 1111 | Normal value |
| 1110 | 15 frames prior to switching |
| 1101 | 14 frames prior to switching |
| 1100 | 13 frames prior to switching |
| . . . | . . . |
| 0010 | 3 frames prior to switching |
| 0001 | 2 frames prior to switching |
| 0000 | 1 frame prior to switching |

The receiver 100 verifies whether the fourth data sequence in the received data stream corresponding to the fourth data sequence field (bits B22 to B25) is the data sequence field of indicator of transmission parameter switching. The verification mechanism of the indicator of transmission parameter switching data sequence may be represented by a program code below:

match_para_switch=(B22-B25==1111)

In the above program code, match_para_switch represents a fourth flag of successful synchronization verification.

After completing the verification of the indicator of transmission parameter switching data sequence, the receiver 100 verifies whether a fifth data sequence in the received data stream corresponding to a fifth data sequence field satisfies a condition to determine whether the fifth data sequence of the fifth data sequence field is synchronous. The fifth data sequence field may be a data sequence field of carrier modulation scheme, which corresponds to the carrier modulation scheme data sequence at bits B28 to B30, B41 to B43, B54 to B56, B68 to B70, B81 to B83 and B94 to B96. The carrier modulation scheme data sequence is defined in the ISDB-T specification as a table below:

| Value of carrier modulation | |
|---|---|
| scheme data sequence | Meaning |
| 000 | DQPSK modulation |
| 001 | QPSK modulation |
| 010 | 16QAM |
| 011 | 64QAM |
| 100 and 110 | Reserved |
| 111 | Unused hierarchical layer |

The receiver 100 verifies whether the data sequence in the received data stream corresponding to the fifth data sequence field (bits B28 to B30, B41 to B43, B54 to B56, B68 to B70, B81 to B83 and B94 to B96) and the carrier modulation scheme data sequence satisfy a matching condition. The verification mechanism of the carrier modulation scheme data sequence may be represented by a program code below:

Match_modulation=(match_mod_a&&match_mod_b&&match_mod_c)
Match_mod_a=!(Reserved_a_1∥Reserved_a_2∥unused_a)
Match_mod_b=!(Reserved_b_1∥Reserved_b_2)
Match_mod_c=!(Reserved_c_1∥Reserved_c_2)
Reserved_a_1=(B28-B30==100), Reserved_a_2=(B28-B30==110), unused_a=(B28-B30==111)
Reserved_b_1=(B41-B43==100), Reserved_b_2=(B41-B43==100)
Reserved_c_1=(B54-B56==100), Reserved_c_2=(B54-B56==100)

In the above program code, Match_modulation represents a fifth flag of successful synchronization verification.

After completing the verification mechanism of the carrier modulation scheme data sequence, the receiver 100 verifies whether a sixth data sequence in the received data streams corresponding to a sixth data sequence field satisfies a condition to determine whether the sixth data sequence of the sixth data sequence field is synchronous. The sixth data sequence field may be a data sequence field of carrier convolutional coding rate, which corresponds to the carrier convolutional coding rate data sequence at bits B31 to B33, B44 to B46, B57 to B59, B71 to B73, B84 to B86 and B97 to B99. The carrier convolutional coding rate data sequence is defined in the ISDB-T specification as a table below:

| Value of carrier convolutional | |
|---|---|
| coding rate | Meaning |
| 000 | 1/2 |
| 001 | 2/3 |
| 010 | 3/4 |
| 011 | 5/6 |
| 100 | 7/8 |
| 101 and 110 | Reserved |
| 111 | Unused hierarchical layer |

The receiver 100 verifies whether the data sequence in the received data stream corresponding to the sixth data sequence field (bits B31 to B33, B44 to B46, B57 to B59, B71 to B73, B84 to B86 and B97 to B99) and the carrier convolutional coding rate data sequence satisfy a matching condition. The verification mechanism of the carrier convolutional coding rate data sequence may be represented as a program code below:

Match_coderate=(match_coderate_a&&match_coderate_b&&match_coderat e_c)
Match_coderate_a=!(Reserved_a_1∥Reserved_a_2∥unused_a)
Match_coderate_b=!(Reserved_b_1∥Reserved_b_2)
Match_coderate_c=!(Reserved_c_1∥Reserved_c_2)
Reserved_a_1=(B31-B33==101), Reserved_a_2=(B31-B33==110), unused_a=(B31-B33==111)
Reserved_b_1=(B44-B46==101), Reserved_b_2=(B44-B46==110)
Reserved_c_1=(B57-B59==101), Reserved_c_2=(B57-B59==110)

In the above program code, Match_conderate represents a sixth flag of successful synchronization verification.

After completing the verification mechanism of the carrier convolutional coding rate data sequence, the receiver 100 verifies whether a seventh data sequence in the data stream corresponding to a seventh data sequence field satisfies a condition to determine whether the seventh data sequence of the seventh data sequence field is synchronous. The seventh data sequence may be a data sequence field of signal interleaving length, which corresponds to the signal interleaving length data sequence at the bits B34 to B36, B47 to B49, B60 to B62, B74 to B76, B87 to B89 and B100 to B102. The signal interleaving length data sequence is defined in the ISDB-T specification as a table below:

| Value of signal interleaving | |
|---|---|
| length data sequence | Meaning (mode) |
| 000 | 0 (mode 1), 0 (mode 2), 0 (mode 3) |
| 001 | 4 (mode 1), 2 (mode 2), 1 (mode 3) |
| 010 | 8 (mode 1), 4 (mode 2), 2 (mode 3) |
| 011 | 16 (mode 1), 8 (mode 2), 4 (mode 3) |
| 100 and 110 | Reserved |
| 111 | Unused hierarchical layer |

The receiver 100 verifies whether the data sequence in the received data stream corresponding to the seventh data sequence field (bits B34 to B36, B47 to B49, B60 to B62, B74 to B76, B87 to B89 and B100 to B102) and the signal interleaving length data sequence satisfy a matching condition. The verification mechanism of the signal interleaving length data sequence may be represented by a program code below:

Match_interleaving=(match_interleaving_a&&match_interleaving_b&&match_interleaving_c)
Match_interleaving_a=!(Reserved_a_1∥Reserved_a_2∥unused_a)
Match_interleaving_b=!(Reserved_b_1∥Reserved_b_2)
Match_interleaving_c=!(Reserved_c_1∥Reserved_c_2)
Reserved_a_1=(B34-B36==100), Reserved_a_2=(B34-B36==110), unused_a=(B34-B36==111)
Reserved_b_1=(B47-B49==100), Reserved_b_2=(B47-B49==110)
Reserved_c_1=(B60-B62==100), Reserved_c_2=(B60-B62==110)

In the above program code, Match_interleaving represents a seventh flag of successful synchronization verification.

After completing the verification mechanism of the signal interleaving length data sequence, the receiver 100 verifies whether an eighth data sequence in the data stream corresponding to an eight data sequence field satisfy a condition to determine whether the eighth data sequence of the eighth data sequence field is synchronous. The eighth data sequence may be a data sequence field of number of segment, which corresponds to the number of segment data sequence at the bits B37 to B40, B50 to B53, B63 to B66, B77 to B80, B90 to B93 and B103 to B106. The data segment number data sequence is defined in the ISDB-T specification as a table below:

| number of segment data | |
|---|---|
| sequence | Meaning |
| 0000 | Reserved |
| 0001 | 1 segment |
| 0010 | 2 segments |
| 0011 | 3 segments |
| 0100 | 4 segments |
| 0101 | 5 segments |
| 0110 | 6 segments |
| 0111 | 7 segments |
| 1000 | 8 segments |
| 1001 | 9 segments |
| 1010 | 10 segments |
| 1011 | 11 segments |
| 1100 | 12 segments |
| 1101 | 13 segments |
| 1110 | Reserved |
| 1111 | Unused hierarchical layer |

The receiver 100 verifies whether the data sequence in the received data stream corresponding to the eighth data sequence field (the bits B37 to B40, B50 to B53, B63 to B66, B7 to B80, B90 to B93 and B103 to B106) and the number of segment data sequence satisfy a matching condition. The verification mechanism of the number of segment data sequence may be represented by a program code below:

match_segment_number=(match_segment_a&&match_segment_b&&match_segment_c)
Match_{—} segment_a=!(Reserved_a_1∥Reserved_a_2∥unused_a)
Match_{—} segment_b=!(Reserved_b_1∥Reserved_b_2)
Match_{—} segment_c=!(Reserved_c_1∥Reserved_c_2)
Reserved_a_1=(B37-B40==0000), Reserved_a_2=(B37-B40==1110), unused_a=(B37-B40==1111)
Reserved_b_1=(B50-B53==0000), Reserved_b_2=(B50-B53==1110)
Reserved_c_1=(B63-B66==0000), Reserved_c_2=(B63-B66==1110)

In the above program code, match_segment_number represents an eighth flag of successful synchronization verification.

The synchronization method for eight different data sequences in the TMCC data stream is as described. When a data sequences passes synchronization verification, a corresponding flag of successful synchronization verification is returned. In a more strict embodiment, according to the first flag of successful synchronization verification (the synchronizing signal sequence having passed synchronization verification), the second flag of synchronization verification (the data segment identification data sequence having passed synchronization verification), the third flag of successful synchronization verification (the system identification data sequence having passed synchronization verification), the fourth flag of successful synchronization verification (the indicator of transmission parameter switching data sequence having passed synchronization verification), the fifth flag of successful synchronization verification (the carrier modulation scheme data sequence having passed synchronization verification), the sixth flag of successful synchronization verification (the carrier convolutional coding rate data sequence having passed synchronization verification), the seventh flag of successful synchronization verification (the signal interleaving length data sequence having passed synchronization verification), and the eighth flag of successful synchronization verification (the number of segment data sequence having passed synchronization verification), the receiver 100 determines that the TMCC data stream is synchronous, and retrieves the data in the fields corresponding to the bits B0 to B66. At this point, if the receiver 100 determines that the TMCC data stream is synchronous according to all of the flags of successful synchronization verification, a program code may be represented as:

match_tmcc_information=match_sync_word(1) &&match_segment_type(2) &&
match_system_id(3)&&match_para_switch(4)&&match_modulation(5)&&match_coderate(6)&&match_interleaving(7)&&match_segment_number(8)

In the above program code, match_tmcc_information represents the flag of synchronization verification of the TMCC data stream. For example, when match_tmcc_information=1, it means that the TMCC data stream is synchronous, and the data in the TMCC data frame can be directly retrieved.

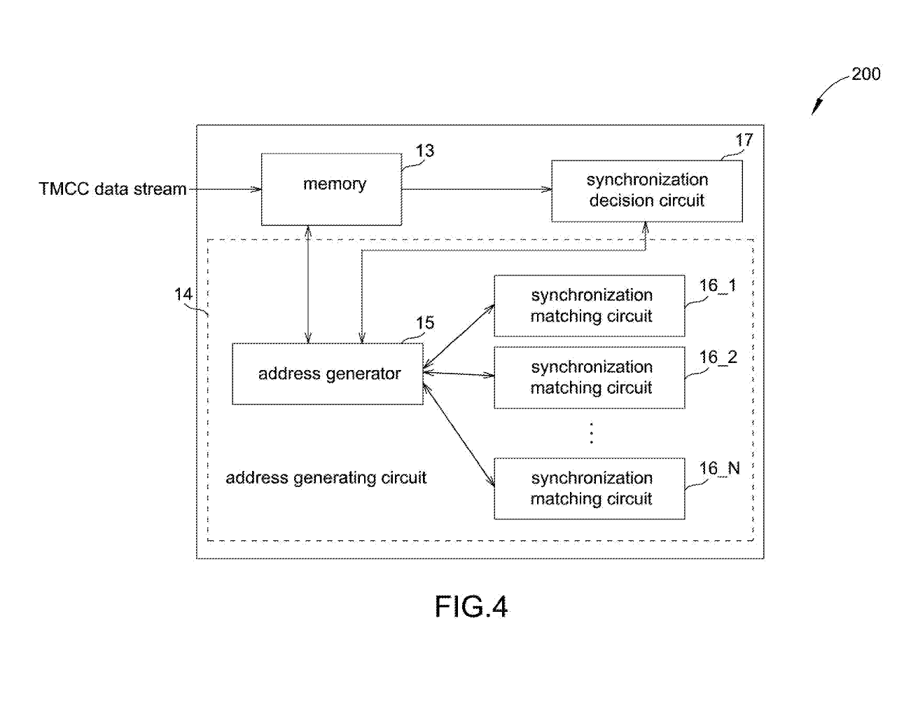

To accordingly implement the synchronization detection method of the present invention, details of a hardware structure and functions of the synchronization detection decoding circuit 200 of the TMCC decoder 11 are given below. FIG. 4 shows a block diagram of the synchronization detection decoding circuit 200 of the TMCC decoder 11. The synchronization detection decoding circuit 200 includes a memory 13, an address generator 14 and a synchronization decision circuit 17. The memory 13 may be any device supporting a storage/buffering data function, e.g., a static random access memory (SRAM) or a first-in-first-out (FIFO) memory device, and buffers a TMCC data stream. The address generating circuit 14, coupled to the memory 13, outputs a plurality of addresses corresponding to a plurality of data sequence fields according to the TMCC data stream that the memory 13 buffers. The address generating circuit 14 may include an address generator 15 and a plurality of synchronization matching circuits 16_1 to 16_N, where N is a positive integer. The plurality of synchronization matching circuits 16_1 to 16_N generates data of the plurality of addresses. For example, the synchronization matching circuit 16_1 provides address data corresponding to the field of synchronizing signal sequence, the synchronization matching circuit 16_2 generates address data corresponding to the data sequence field of data segment identification, the synchronization matching circuit 16_3 generates address data corresponding to the data sequence field of system identification, the synchronization matching circuit 16_4 generates address data corresponding to the data sequence field of indicator of transmission parameter switching, the synchronization matching circuit 16_5 generates address data corresponding to the data sequence field of carrier modulation scheme, the synchronization matching circuit 16_6 generates address data corresponding to the data sequence field of carrier convolutional coding rate, the synchronization matching circuit 16_7 generates address data corresponding to the data sequence field of signal interleaving length, and the synchronization matching circuit 16_8 generates address data corresponding to the data sequence field of number of segment. The address generator 15, coupled to the memory 13 and the plurality of synchronization matching circuits 16_1 to 16_N, generates a plurality of addresses corresponding to the plurality of data sequence fields according to the data of a plurality of addresses that the synchronization matching circuits 16_1 to 16_N generate. For example, the data of the plurality of addresses that the synchronization matching circuits 16_1 to 16_N generate may include pattern data of the predetermined data sequences defined in the specification. The address generator 15 reads the pattern data of the predetermined data sequences that the synchronization matching circuits generate and generates corresponding addresses, and transmits the same to the synchronization decision circuit 17. In the synchronization detection decoding circuit 200, the synchronization decision circuit 17 is coupled to the memory 13 and the address generating circuit 14. Thus, the synchronization decision circuit 17 receives the information of the TMCC data stream buffered in the memory 13, and the pattern data of the predetermined data sequences and the corresponding address information transmitted from the address generating circuit 14. Next, the synchronization decision circuit 17 fetches the data sequences of predetermined addresses in the TMCC data stream, and compares the fetched data sequences with patterns of predetermined data sequences defined in the specifications according to the steps of the synchronization detection method in the foregoing description to determine whether the TMCC data stream is synchronous.

It should be noted that, the synchronization detection decoding circuit 200 of the present invention is not limited to having the structure described above. For example, in other embodiments, the address generating circuit 14 may be integrated with the plurality of synchronization matching circuits 16_1 to 16_N. In other words, without going through the address generating circuit 14, the plurality of synchronization matching circuits 16_1 to 16_N are capable of directly outputting pattern data of predetermined data sequences and the corresponding addresses. In this embodiment, the data of the plurality of addresses generated by the synchronization matching circuits 16_1 to 16_N is the addresses corresponding to the pattern data of the predetermined data sequences. Further, in other embodiments, in the synchronization detection method performed by the synchronization detection decoding circuit 200, the steps of detecting whether the data in each of the data sequence fields is synchronous may be performed not according to the order in the foregoing description, or may be simultaneously performed. For example, the plurality of synchronization matching circuits 16_1 to 16_N may simultaneously generate the pattern data of N predetermined data sequences, the address generating circuit 14 may simultaneously read the pattern data of the N predetermined data sequences and simultaneously generate N corresponding addresses, and the synchronization decision circuit 17 may simultaneously compare the data sequences of the N corresponding addresses in the TMCC data stream according to the pattern data of the N predetermined data sequences to determine whether the TMCC data stream is synchronous.

It should be noted that, the synchronization detection method of the present invention is not limited to applications of an ISDB-T system, and may also be applied to a DVB-T system. The approach of determining data synchronization of a DVB-T system is similar to that of an ISDB-T system, with one difference being that, the definition of each of the data sequence fields and the corresponding data sequences in a DVB-T system are different from those in an ISDB-T system. Associated details are given below.

The flowchart of a synchronization detection method of a DVB-T system is identical to the flowchart in FIG. 3. For simple illustrations, details of the synchronization detection method of a DVB-T system are given with reference to the process in FIG. 3. In step S301, the receiver 300 receives a transmission parameter signaling (TPS) data stream of a DVB-T system, with however the TPS data stream not necessarily being synchronous at the receiver 100. In step S302, the receiver 100 verifies whether a first data sequence in the data stream corresponding to a first data sequence field satisfies a condition to determine whether the first data sequence of the first data sequence field is synchronous. The first data sequence field may be a field of synchronizing signal sequence, which corresponds to the synchronization signal sequence at bits B1 to B16. The synchronizing signal sequence is defined in the DVB-T specification as a table below:

| Index of data frame | Synchronizing signal sequence |
|---|---|
| Frame #1 | 0011010111101110 |
| Frame #2 | 1100101000010001 |
| Frame #3 | 0011010111101110 |
| Frame #4 | 1100101000010001 |

The receiver 100 verifies whether the data sequence in the data stream corresponding to the first data sequence field (bits B1 to B16) is a synchronizing signal sequence. The verification mechanism of the synchronizing signal sequence may be represented by a program code below:

Match_sync=(B1˜B16==0011010111101110)∥(B1-B16==1100101000010001)

In the above program code, Match_sync represents a first flag of successful synchronization verification.

In step S305, the receiver 100 verifies whether a second data sequence in the data stream corresponding to a second data sequence field satisfies a condition to determine whether the second data sequence of the second data sequence field is synchronous. The second data sequence field may be a data sequence field of transmission parameter signal (TPS) length indicator, which corresponds to the TPS length indicator data sequence at the bits B17 to B22. The TPS length indicator data sequence is defined in the DVB-T specification as a table below:

| TPS length | Contents of data sequence |
|---|---|
| 23 TPS bits | 010111 |
| 31 TPS bits | 011111 |

The receiver 100 verifies whether the data sequence in the received data stream corresponding to the second data sequence field (bits B17 to B22) is the data sequence of TPS length indicator. The verification mechanism of the TPS length indicator data sequence may be represented by a program code below:

Match_length=(B17˜B22==010111)∥(B17˜B22==011111)

In the above program code, Match_length represents a second flag of successful synchronization verification.

When the first flag of successful synchronization verification and the second flag of successful synchronization verification are received, it means that the TPS data stream is synchronous, and the data in the data stream may be directly retrieved according to step S308.

To further enhance the accuracy of synchronization detection, the synchronization verification method of the present invention applied to a DVB-T system may add a step of multiple verification sequences between steps S307 and S308 in the process in FIG. 3, as described below. After step S307 is performed, the receiver 100 verifies whether a third data sequence in the data stream corresponding to a third data sequence field satisfies a condition to determine whether the third data sequence of the third data sequence field is synchronous. The third data sequence field may be a data sequence field of constellation, which corresponds to a constellation data sequence at bits B25 to B26. The constellation data sequence is defined in the DVB-T specification as a table below:

| Value of constellation data | |
|---|---|
| sequence | Meaning |
| 00 | QPSK |
| 01 | 16QAM |
| 10 | 64QAM |
| 11 | Reserved |

The receiver 100 verifies whether the data sequence in the received data stream corresponding to the third data sequence field (bits B25 to B26) is the data sequence field of constellation. The verification mechanism of the constellation data sequence may be represented by a program code below:

Match_constellation=(B25-B26!=11)

In the above program code, Match_constellation represents a third flag of successful verification.

After completing the above verification mechanism of the constellation data sequence, the receiver 100 verifies whether a fourth data sequence in the data stream corresponding to a fourth data sequence field satisfies a condition to determine whether the fourth data sequence of the fourth data sequence field is synchronous. The fourth data sequence field may be a data sequence field of code rate, which corresponds to a code rate data sequence at bits B30 to B32 and B33 to B35. The code rate data sequence is defined in the DVB-T specification as a table below:

| Value of code rate data | |
|---|---|
| sequence | Meaning (code rate) |
| 000 | 1/2 |
| 001 | 2/3 |
| 010 | 3/4 |
| 011 | 5/6 |
| 100 | 7/8 |
| 101 | Reserved |
| 110 | Reserved |
| 111 | Reserved |

The receiver 100 verifies whether the fourth data sequence in the received data stream corresponding to the fourth data sequence field (bits B30 to B32 and B33 to B35) satisfies a matching condition. The code rate data sequence may be represented by a program code below:

Match_coderate_H=!((B30˜B32==101)∥(B30˜B32==110)∥(B30˜B32==111))
Match_coderate_L=!((B33˜B35==101)∥(B33˜B35==110)∥(B33˜B35==111))
Match_coderate=(Match_coderate_H&&Match_coderate_L)

In the above program code, Match_coderate represents a fourth flag of successful verification.

After completing the verification of the code rate data sequence, the receiver 100 verifies whether a fifth data sequence in the data stream corresponding to a fifth data sequence field satisfies a condition to determine whether the fifth data sequence of the fifth data sequence field is synchronous. The fifth data sequence field may be a data sequence field of transmission mode, which corresponds to the transmission mode data sequence at bits B38 to B39. The transmission mode data sequence is defined in the DVB-T system as a table below:

| Value of transmission mode | |
|---|---|
| data sequence | Meaning |
| 00 | First mode |
| 01 | Second mode |
| 10 | Third mode |
| 11 | Reserved |

The values in the transmission mode data sequence represent different modes, e.g., the first mode may be a 2 K mode and the second mode may be an 8 K mode. The receiver 100 verifies whether the data sequence in the received data stream corresponding to the fifth data sequence field (bits B38 to B39) satisfies a matching condition. The verification mechanism of the transmission mode data sequence may be represented as a program code below:

Match_mode=(B38˜B39!=11)

In the program code above, Match_mode represents a fifth flag of successful synchronization verification.

Similar to the synchronization verification method for a TMCC stream of the present invention applied to a ISDB-T system, in the synchronization verification method for a TPS stream of the present invention applied to a DVB-T system, when a data sequences passes synchronization verification, a corresponding flag of successful synchronization verification is returned. The data contents in the TPS data stream can then be directly retrieved when the TPS data stream is determined as synchronous. In a more strict embodiment, according to the first flag of successful synchronization verification (the synchronizing signal sequence having passed synchronization verification), the second flag of synchronization verification (the TPS length indicator data sequence having passed synchronization verification), the third flag of successful synchronization verification (the constellation data sequence having passed synchronization verification), the fourth flag of successful synchronization verification (the code rate data sequence having passed synchronization verification), and the fifth flag of successful synchronization verification (the transmission mode data sequence having passed synchronization verification), the receiver 100 determines that the TPS data stream is synchronous, and directly retrieves the data contents in the TPS data stream.

When the present invention is applied to a DVB-T system, the functions of the receiver 100, the processor and the memory are similar to those when the present invention is applied to an ISDB-T system. Details of the implementation are similar to the hardware operations of the foregoing ISDB-T system, and shall be omitted herein. Further, the abovementioned program codes are program codes in a C language, and may be re-written in other hardware description language such as Verilog by one person skilled in the art and then converted to digital logic circuits capable of performing synchronization detection.

In conclusion, the present invention provides a method for quickly detecting data stream synchronization of a TMCC data stream at a receiver of an ISDB-T system to reduce the time needed for retrieving correct data in the TMCC data stream. Conceptually, the same set of synchronization data sequence is used in conjunction with other several data sequences defined in a TMCC data frame in an ISDB-T system to sequentially verify that these data sequences are synchronous, and corresponding flags of successful synchronization verification are returned. According to these of flags of successful synchronization verification, the TMCC data frame (e.g., an n^{th} data frame in the data stream) is determined as synchronous, and corresponding data in the field can then be retrieved. With the synchronization verification mechanism of the present invention, for a guard interval of ⅛ in OFDM, the data in a TMCC data frame can be captured in 75.978 ms, which is significantly shorter than the time (250.614 ms) needed in a conventional approach. Even in a worst scenario, the time needed in the present invention is 306.18 ms, which is not much different from the optimal scenario in a convention approach. Further, the fast synchronization detection method of the present invention is applicable to a DVB-T system, and at least reduces 50.4 ms delay for a guard interval of ¼ in OFDM, hence reducing the time needed for channel selection and channel scanning as well as increasing user operation efficiency.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for detecting data stream synchronization in a digital broadcasting system, comprising:
receiving a data stream by a receiver;
verifying a first data sequence in the data stream corresponding to a first data sequence field;
generating a first flag of successful synchronization verification when the first data sequence is successfully verified;
verifying a second data sequence in the data stream corresponding to a second data sequence field; and
generating a second flag of successful synchronization verification when the second data sequence is successfully verified;
wherein, the first data sequence field is a field of synchronizing signal sequence, the second data sequence field is a data sequence field of data segment type identification, and the second data sequence is located subsequent to the first data sequence.

2. The method according to claim 1, wherein the field of synchronizing signal sequence corresponds to the field of synchronizing signal sequence defined in the Integrated Digital Service Broadcasting-Terrestrial (ISDB-T) specification.

3. The method according to claim 2, wherein the field of synchronizing signal sequence is a field of 16-bit synchronizing signal sequence.

4. The method according to claim 2, further comprising:
after receiving the first flag and second flag of successful synchronization verification, synchronously retrieving data in the data stream.

5. The method according to claim 2, further comprising:
verifying a third data sequence in the data stream corresponding to a third data sequence field; and
generating a third flag of successful synchronization verification when the third data sequence is successfully verified;
wherein, the third data sequence field is a data sequence field of system identification.

6. The method according to claim 5, further comprising:
verifying a fourth data sequence in the data stream corresponding to a fourth data sequence field; and
generating a fourth flag of successful synchronization verification when the fourth data sequence is successfully verified;
wherein, the fourth data sequence field is a data sequence field of indicator of transmission parameter switching.

7. The method according to claim 6, further comprising:
verifying a fifth data sequence in the data stream corresponding to a fifth data sequence field; and
generating a fifth flag of successful synchronization verification when the fifth data sequence is successfully verified;
wherein, the fifth data sequence field is a data sequence field of carrier modulation scheme.

8. The method according to claim 7, further comprising:
verifying a sixth data sequence in the data stream corresponding to a sixth data sequence field; and
generating a sixth flag of successful synchronization verification when the sixth data sequence is successfully verified;
wherein, the sixth data sequence field is a data sequence field of carrier convolutional coding rate.

9. The method according to claim 8, further comprising:
verifying a seventh data sequence in the data stream corresponding to a seventh data sequence field; and
generating a seventh flag of successful synchronization verification when the seventh data sequence is successfully verified;
wherein, the seventh data sequence field is a data sequence field of signal interleaving length.

10. The method according to claim 9, further comprising:
verifying an eighth data sequence in the data stream corresponding to an eighth data sequence field; and
generating an eighth flag of successful synchronization verification when the eighth data sequence is successfully verified;
wherein, the eighth data sequence field is a data sequence field of data segment number.

11. A method for detecting data stream synchronization in a digital broadcasting system, comprising:
receiving a data stream by a receiver;
verifying a first data sequence in the data stream corresponding to a first data sequence field;
generating a first flag of successful synchronization verification when the first data sequence is successfully verified;
verifying a second data sequence in the data stream corresponding to a second data sequence field; and
generating a second flag of successful synchronization verification when the second data sequence is successfully verified;
wherein, the first data sequence field is a field of synchronizing signal sequence, the second data sequence field is a non-synchronizing signal sequence, and the first data sequence and the second data sequence are located in a same data frame.

12. The method according to claim 11, wherein the second data sequence is located subsequent to the first data sequence.

13. The method according to claim 11, wherein the non-synchronizing signal sequence is selected from a group consisting of a data sequence field of data segment type identification, a data sequence field of system identification, a data sequence field of indicator of transmission parameter switching, a data sequence field of carrier modulation scheme, a data sequence field of carrier convolutional coding rate, a data sequence field of signal interleaving length, a data sequence field of data segment number, a data sequence field of transmission parameter signal (TPS) length indicator, a data sequence field of constellation, a data sequence field of code rate and a data sequence field of transmission mode.

14. A method for detecting data stream synchronization, comprising:
receiving a data stream by a receiver;
verifying a first data sequence in the data stream corresponding to a first data sequence field;
generating a first flag of successful synchronization verification when the first data sequence is successfully verified;
verifying a second data sequence in the data stream corresponding to a second data sequence field; and
generating a second flag of successful synchronization verification when the second data sequence is successfully verified;
wherein, the first data sequence field is a field of synchronizing signal sequence, the second data sequence field is a data sequence field of transmission parameter signal (TPS) signal length indicator, and the second data sequence is located subsequent to the first data sequence.

15. The method according to claim 14, further comprising:
after receiving the first flag and second flag of successful synchronization verification, synchronously retrieving data in the data stream.

16. The method according to claim 14, further comprising:
verifying a third data sequence in the data stream corresponding to a third data sequence field; and
generating a third flag of successful synchronization verification when the third data sequence is successfully verified;
wherein, the third data sequence field is a data sequence field of constellation.

17. The method according to claim 16, further comprising:
verifying a fourth data sequence in the data stream corresponding to a fourth data sequence field; and
generating a fourth flag of successful synchronization verification when the fourth data sequence is successfully verified;
wherein, the fourth data sequence field is a data sequence field of code rate.

18. The method according to claim 17, further comprising:
verifying a fifth data sequence in the data stream corresponding to a fifth data sequence field; and
generating a fifth flag of successful synchronization verification when the fifth data sequence is successfully verified;
wherein, the fifth data sequence field is a data sequence field of transmission mode.

19. A synchronization detection decoding circuit, comprising:
a memory, buffering a data stream;
an address generating circuit, coupled to the memory, outputting a plurality of addresses in the data stream corresponding to a plurality of data sequence fields, comprising a plurality of synchronization matching circuits that generate data of the plurality of addresses; and
a synchronization decision circuit, coupled to the memory and the address generating circuit, determining whether the data stream is synchronous according to the plurality of addresses corresponding to the plurality of data sequence fields.

20. The decoding circuit according to claim 18, wherein the address generating circuit further comprises:
an address generator, coupled to the memory and the plurality of matching circuits, generating the plurality of addresses corresponding to the plurality of data sequence fields according to the data of the plurality of addresses that the plurality of synchronization matching circuits generate.
